(19) United States
(12) Patent Application Publication
(10) Pub. No.: US 2003/0146093 A1
(43) Pub. Date: Aug. 7, 2003

(54) Oxygen sensor

(75) Inventors: Masahide Akiyama, Kokubu (JP); Kouji Tokunaga, Kokubu (JP)

Correspondence Address: HOGAN & HARTSON L.L.P., 500 S. GRAND AVENUE, SUITE 1900, LOS ANGELES, CA, 90071-2611, US

(73) Assignee: KYOCERA CORPORATION

(21) Appl. No.: 10/358,490

(22) Filed: Feb. 4, 2003

(30) Foreign Application Priority Data
Feb. 5, 2002 (JP) 2002-28530
Feb. 20, 2002 (JP) 2002-43753
Feb. 21, 2002 (JP) 2002-45270
Mar. 27, 2002 (JP) 2002-87280

(51) Int. Cl. G01N 27/26

(52) U.S. Cl. 204/424; 204/431; 204/412

(57) ABSTRACT

An oxygen sensor forming a sensing element which comprises a solid electrolytic substrate of ziconia of the shape of an elongated flat plate, a measuring electrode and a reference electrode which are formed of platinum, said measuring electrode and said reference electrode being formed on both opposing surfaces at an end of said solid electrolytic substrate so as to be opposed to each other, wherein said measuring electrode has an electrode area of from 8 to 18 mm², and said sensing element has a width w of from 2.0 to 3.5 mm at the end of the solid electrolytic substrate. The oxygen sensor exhibits excellent gas response performance, can be quickly heated and is small in size.

### BACKGROUND OF THE INVENTION

1. Field of the Invention

The present invention relates to an oxygen sensor and, particularly, to an oxygen sensor for controlling the ratio of the air and the fuel in automotive engines.

2. Description of the Related Art

Modern automotive internal combustion engines are now employing a method of removing harmful substances such as CO, HC and NOx emitted from the internal combustion engines by detecting the oxygen concentration in the exhaust gas and by controlling the amounts of the air and the fuel fed to the internal combustion engines based upon the detected value of oxygen concentration.

As the detecting device, there has chiefly been used an oxygen sensor of a solid electrolyte type containing a cylindrical tube, of which the one end is sealed, formed by a solid electrolyte comprising chiefly zirconia having oxygen ion-conducting property, and a pair of electrode layers mounted on the outer surface and on the inner surface of the cylindrical tube.

As schematically illustrated in a sectional view of FIG. 9, a conventional representative oxygen sensor includes a cylindrical tube 31 made of a ZrO₂ solid electrolyte and of which the end is sealed, a reference electrode 32 formed on an inner surface of the cylindrical tube 31 at an end thereof, and a measuring electrode 33 formed on an outer surface of the cylindrical tube 31 at an end thereof. The reference electrode 32 comes in contact with a reference gas such as the air, the measuring electrode 33 comes in contact with a gas to be measured such as exhaust gas, and the end of the cylindrical tube 31 works as a sensing element.

In the oxygen sensor or in a so-called stoichiometric air-fuel ratio sensor (λ sensor) which is used for controlling the ratio of the air and the fuel to be nearly 1, a ceramic porous layer 34 is formed as a protection layer on the surface of the measuring electrode 33, and a difference in the oxygen concentration between both sides of the cylindrical tube 31 is detected at a predetermined temperature to control the air-fuel ratio in the engine intake system. Here, the sensor unit of the stoichiometric air-fuel ratio sensor must be heated up to an operation temperature of nearly about 70° C. For this purpose, a rod-like heater 35 is inserted in the cylindrical tube 31.

In recent years, however, stringent regulations have been imposed on the emission of exhaust gases, and it has been urged to detect CO, HC and NOx right after the start of the engine. The cylindrical oxygen sensor of the indirectly heating type having the heater 35 inserted in the cylindrical tube 31, requires an extended period of time (hereinafter referred to as activating time) before the sensing element is heated to an activating temperature making it difficult to sufficiently cope with the regulations related to the exhaust gases.

To improve this defect, there has recently been proposed an oxygen sensor having a structure as illustrated in FIGS. 10a and 10b which are a schematic sectional view thereof and a schematic plan view thereof. In this oxygen sensor, a measuring electrode 37 is formed on the outer surface of a flat plate-like solid electrolytic substrate 36, and a reference electrode 38 is formed on the inner surface of the solid electrolytic substrate 36. Further, a ceramic insulating layer 39 burying a platinum heater 40 therein is provided on the inner surface of the solid electrolytic substrate 36 integrally therewith, thereby to constitute the oxygen sensor of a structure incorporating the heater integrally together.

The oxygen sensor incorporating the heater integrally together is employing a direct heating system and can be quickly heated. However, since the sensing element is great, the oxygen sensor cannot be heated quickly enough, still exhibiting low gas response performance.

### SUMMARY OF THE INVENTION

It is, therefore, an object of the present invention to provide a small oxygen sensor which can be quickly heated to exhibit excellent gas response performance.

While studying the above problem, the present inventors have discovered that the gas response performance is very intimately related to the area of the measuring electrode and to the width of the sensing element and that the gas response performance can be enhanced by controlling them to possess predetermined sizes while decreasing the size of the oxygen sensor, and have arrived at the present invention.

Namely, according to the present invention, there is provided an oxygen sensor comprising a solid electrolytic substrate of ziconia of the shape of an elongated flat plate, a measuring electrode and a reference electrode, the measuring electrode and the reference electrode being formed on both opposing surfaces at an end point of the solid electrolytic substrate so as to be opposed to each other and forming a sensing element, wherein the measuring electrode has an electrode area of from 8 to 18 mm², and the sensing element has a width w of from 2.0 to 3.5 mm at the end of the solid electrolytic substrate.

In the present invention, in general, the measuring electrode is formed on the outer surface of the solid electrolytic substrate of zirconia, the reference electrode is formed on the inner surface of the solid electrolytic substrate of zirconia, a ceramic cover having a reference gas introduction hole is provided on the inner surface of the solid electrolytic substrate of a zirconia, and the reference electrode is exposed in the reference gas introduction hole. Namely, the reference electrode comes in contact with the reference gas such as air introduced into the reference gas introduction hole, and the measuring electrode formed on the outer surface of the solid electrolytic substrate comes in contact with the gas to be measured, such as the exhaust gas, whereby a portion where the reference electrode and the measuring electrode are formed works as a sensing element.

In the oxygen sensor of the present invention as will be described later by way of Experiment, the electrode area of the measuring electrode and the width w of the sensing element at a side of the front end of the solid electrolytic substrate, are set to lie within the above-mentioned ranges, in order to greatly shorten the activating time and to quickly raise the temperature, thereby to markedly enhance the gas response performance.

In the oxygen sensor of the present invention having a sensing element formed in an end thereof, it is desired that a thickness t (mm) thereof satisfies a condition represented by the following formula,

3≦w·t²≦28

wherein w is a width (mm) of the sensing element at the side of the front end of the solid electrolytic substrate,

from the standpoint of increasing the strength of the sensing element while maintaining excellent gas response performance and decreasing the size of the sensor.

In the present invention, further, it is desired that a heater device made of a ceramic insulator burying a heat-generating member therein is provided on the ceramic cover. The heater device can be formed by co-firing with the sensing element. Or, the heater device and the sensing element may be separately formed, and may be joined together by using a suitable junction material.

The heater element may be constituted by burying a pair of heat-generating members in a ceramic insulator. Upon burying the pair of heat-generating members at different heights, heat can be generated in large amounts even when the width of the sensing element is decreased, and the sensing element can be quickly heated.

In the present invention, further, a pair of electrode pads electrically connected to the reference electrode and to the measuring electrode, are formed on the outer surface of the solid electrolytic substrate at the rear end thereof, the width of the solid electrolytic substrate (width in a direction at right angles with the lengthwise direction) is decreased continuously or stepwise from the rear end portion toward the end portion thereof, and the width of the pair of electrode pads is decreased to be smaller than the width at the end of the solid electrolytic substrate. Owing to this constitution, the strength of the sensing element can be increased even when it is attempted to decrease the size of the oxygen sensor by decreasing the width of the sensing element and, besides, the voltage and the current can be effectively exchanged between the sensing element and an external circuit.

### BRIEF DESCRIPTION OF THE DRAWINGS

FIGS. 1 and 2 are sectional views schematically illustrating sensing element portions in oxygen sensors of the present invention;

FIGS. 3 and 4 are views illustrating patterns of heat-generating members used in the present invention;

FIGS. 5a to 5c are plan views schematically illustrating the oxygen sensor of the present invention;

FIG. 6 is a view illustrating an oxygen sensor of the invention provided with a mounting jig;

FIG. 7 is a perspective view illustrating, in a disassembled manner, the oxygen sensor of the present invention;

FIG. 8 is a graph illustrating a method of measuring the activating time;

FIG. 9 is a side sectional view schematically illustrating the structure of a conventional cylindrical oxygen sensor incorporating a heater integrally therewith; and

FIGS. 10a and 10b are a side sectional view and a plan view schematically illustrating a conventional oxygen sensor of the type of a flat plate incorporating a heater integrally therewith.

### DETAILED DESCRIPTION OF THE INVENTION

The structure of the oxygen sensor of the invention will now be described in detail with reference to the accompanying drawings.

In the following description, the widths of the members stand for the widths in a direction at right angles with the lengthwise direction of the oxygen sensor (solid electrolytic substrate) unless stated otherwise.

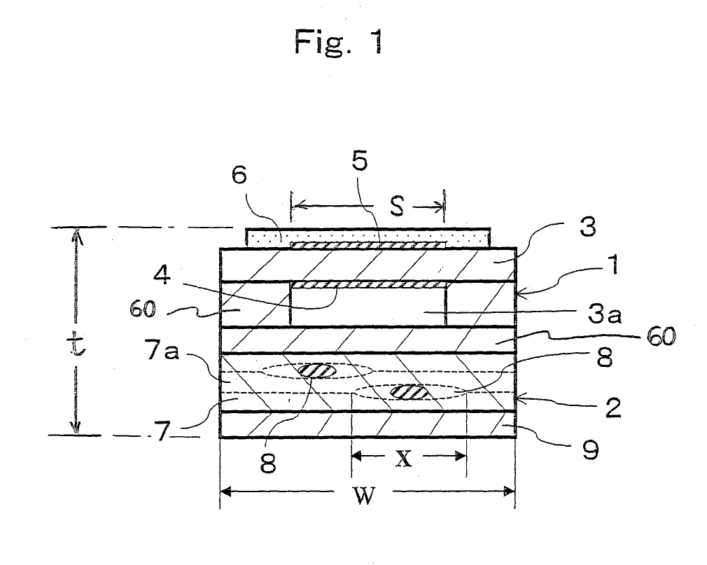

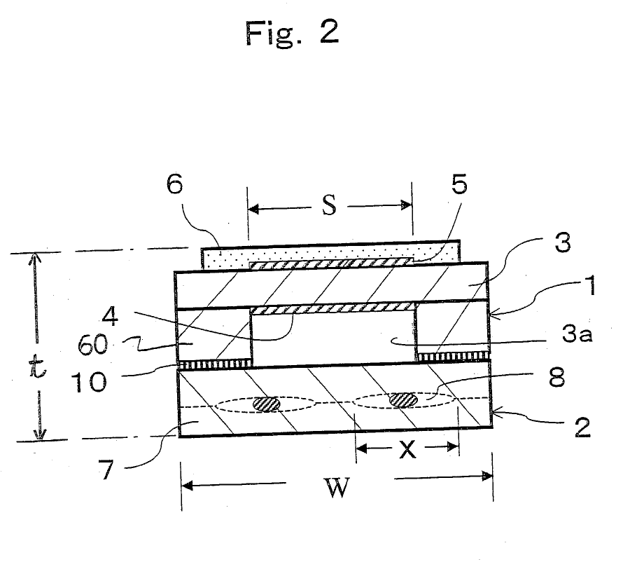

In FIGS. 1 and 2 illustrating the structure of sensing element-forming portions in the oxygen sensors of the present invention, the oxygen sensors are usually called stoichiometric air-fuel ratio sensors (λ sensors). The oxygen sensors of FIGS. 1 and 2 are both provided with a sensing element 1 and a heater device 2.

These oxygen sensors have a solid electrolytic substrate 3 of the shape of an elongated flat plate, and are provided with a reference electrode 4 that comes in contact with a reference gas such as the air and with a measuring electrode 5 that comes in contact with the exhaust gas on both opposing surfaces at an end of the solid electrolytic substrate 3. Namely, these oxygen sensors (solid electrolytic substrates 3) have, at the end portions thereof, a sensing element 1 having a function for detecting the oxygen concentration.

A ceramic cover 60 is formed on the inner surface of the solid electrolytic substrate 3, a reference gas introduction hole 3a having a closed end is formed by the cover 60, and the reference electrode 4 is exposed in the reference gas introduction hole 3a. Namely, a reference gas such as air is introduced into the reference gas introduction hole 3a being separated from the exhaust gas so as to come into contact with the reference electrode 4. The measuring electrode 5, with which will come in contact a gas to be measured such as the exhaust gas, is formed on the outer surface of the solid electrolytic substrate 3 facing the reference electrode 4. The oxygen concentration in the exhaust gas is detected relying upon a potential difference between the reference electrode 4 and the measuring electrode 5.

From the standpoint of preventing the electrode from being contaminated with the exhaust gas, a ceramic porous layer 6 is formed as an electrode protection layer on the surface of the measuring electrode 5.

In the oxygen sensor of the present invention representatively shown in FIG. 1 or 2, it is important that the electrode area S of the measuring electrode 5 is from 8 to 18 mm², preferably, from 10 to 15 mm², and that the width w of the sensing element 1 (width at the side of the end of the solid electrolytic substrate 3) is from 2.0 to 3.5 mm and, preferably, from 2.5 to 3.2 mm and, most preferably, from 2.8 to 3 mm. That is, as will be understood from Table 1 showing the experimental results of Experiment 1 that will be described later, the sensing element 1 itself becomes small when the area of the measuring electrode 5 is smaller than the above range or when the width w of the element 1 is smaller than the above range. In this case, the temperature of the sensing element 1 is not elevated in the engine, and gas response performance is deteriorated. Conversely, when the area of the measuring electrode 5 is greater than the above range or when the width w of the sensing element 1 is greater than the above range, the sensing element 1 becomes large and is not quickly heated.

In these oxygen sensors, further, it is desired that the thickness t (mm) of the oxygen sensors satisfies a condition represented by the following formula,

3≦w·t²≦28

and, particularly,

10≦w·t²≦20

wherein w is the above-mentioned width (mm) of the sensing element 1,

in a portion where the sensing element 1 is formed from the standpoint of rapidly elevating the temperature while maintaining the strength of the sensing element 1 (hereinafter, the parameter w·t² is often called shape factor).

That is, when the value of the shape factor (w·t²) related to the width w of the sensing element 1 and to the sensor thickness t is smaller than the above range, the strength of the sensing element 1 decreases and the sensing element 1 tends to be broken down due to a quick rise in the temperature. When the value of the shape factor exceeds the above range, on the other hand, the volume of the sensor element 1 increases and it becomes difficult to quickly heat the sensing element 1.

The heater device 2, on the other hand, is so constituted that a heat-generating member 8 such as a platinum heater is buried in a ceramic electric insulator. In the oxygen sensor of FIG. 1, the heater element 2 is formed integrally therewith by the co-firing with the sensing element 1. In the oxygen sensor of FIG. 2, the sensing element 1 and the heater device 2 are separately formed and are joined together with a junction member 10. In the oxygen sensor of FIG. 2, further, the ceramic insulator 7 constituting the heater device 2 is serving as part of the ceramic cover 60.

(Solid Electrolytic Substrate 3)

In the oxygen sensor of the present invention having the above-mentioned structure, zirconia ceramic (containing ZrO₂) having oxygen ion-conducting property is used as the solid electrolyte for constituting the substrate 3. As a stabilizer, in particular, there is used partly stabilized ZrO₂ or stabilized ZrO₂ containing oxides of rare earth elements, such as Y₂O₃ and Yb₂O₃, Sc₂O₃, Sm₂O₃, Nd₂O₃ or Dy₂O₃ in an amount of from 1 to 30% by mol and, preferably, from 3 to 15% by mol calculated as oxides.

By using ZrO₂ in which 1 to 20 atomic % of Zr is replaced by Ce, further, the ionic conductivity is improved and the response characteristics are further improved. In order to improve the sintering property, further, there can be used ceramics obtained by adding an assistant such as Al₂O₃ or SiO₂ to the above ZrO₂. When the assistant is contained in large amounts, however, creep properties are deteriorated at high temperatures. It is therefore desired that the total amount of addition of Al₂O₃ and SiO₂ is not larger than 5% by weight and, particularly, not larger than 2% by weight.

(Electrodes 4, 5)

The reference electrode 4 and the measuring electrode 5 deposited on the surfaces of the solid electrolytic substrate 3 are both formed of platinum or an alloy of platinum and one of those selected from the group consisting of rhodium, palladium, ruthenium and gold. Further, the above ceramic solid electrolytic component may be mixed in the above electrodes 4 and 5 at a ratio of from 1 to 50% by volume and, particularly, from 10 to 30% by volume in order to prevent the growth of metal particles in the electrodes when the sensor is in operation and to increase the contact of a so-called three-phase interface among the metal particles related to the response performance, the solid electrolyte and the gas. Further, the electrodes 3 and 4 may have a square shape or an elliptic shape. The electrodes 3 and 4 have a thickness of from 3 to 20 μm and, particularly, from 5 to 10 μm.

(Ceramic Porous Layer 6)

It is desired that the ceramic porous layer 6 formed as a protection layer on the surface of the measuring electrode has a thickness of from 10 to 800 μm, and is formed of at least one selected from the group consisting of zirconia, alumina, r-alumina and spinel having a porosity of 10 to 50%. When the porous layer 6 has a thickness of smaller than 10 μm or has a porosity of larger than 50%, the electrode-contaminating substances such as P and Si easily arrive at the measuring electrode 5 causing the electrode performance to be deteriorated. Further, when the porous layer 6 has a thickness of larger than 800 μm or has a porosity of smaller than 10%, the gas diffuses in the porous layer 6 at a decreased rate and the measuring electrode 5 exhibits deteriorated gas response performance. In particular, it is desired that the porous layer 6 has a thickness of from 100 to 500 μm though it may vary depending upon the porosity.

(Ceramic Insulator 7)

As the ceramic insulator 7 in which the heat-generating member 8 is to be buried, there can be used alumina ceramics, ceramics comprising chiefly a composite oxide of Al and Mg, or insulating ceramics comprising chiefly a composite oxide of Al, Y and at least one rare earth element other than Y. It is further desired that the ceramic insulator 7 has a relative density of not smaller than 80% and an open porosity of not larger than 5%. In order to improve the sintering property, further, it is desired that any insulating ceramics contains Mg, Ca and Si in a total amount of from 1 to 10% by mass calculated as oxides. Here, however, alkali metals such as Na and K migrate to deteriorate the electric insulation of the heater device 2. It is therefore desired that the total amount of alkali metals in the insulating ceramics is controlled to be not larger than 50 ppm calculated as metal oxides. Upon specifying the relative density to lie within the above range, further, the strength of the substrate increases and the oxygen sensor itself exhibits an increased mechanical strength.

(Heat-Generating Member 8)

As the heat-generating member 8 buried in the ceramic insulator 7, there is usually used a simple metal such as platinum or W, or an alloy of platinum and at least any one selected from the group consisting of rhodium, palladium and ruthenium, or an alloy of W and Mo, Re or the like.

(Ceramic Cover 60)

The ceramic cover 60 used for forming the reference gas introduction hole 3a may be made of any ceramics so far as it effectively suppresses the leakage of current from the reference electrode 4. Generally, however, it is desired that the ceramic cover 60 is made of a solid electrolyte (zirconia ceramics) forming the solid electrolytic substrate 3 or insulating ceramics forming the ceramic insulator 7 from the standpoint of moldability and junction strength. When, for example, the sensing element 1 and the heater device 2 are formed integrally together by co-firing like in the oxygen sensor of FIG. 1, it is desired that the ceramic cover as a whole is formed of zirconia ceramics. Further, when the sensing element 1 and the heater element 2 are separately formed and are jointed together with an adhesive 10 like in the oxygen sensor of FIG. 2, it is desired that the side portion only is formed of zirconia ceramics, and the bottom portion thereof is formed of the ceramic insulator 7.

In the oxygen sensor of the invention described above, when a difference in the coefficient of thermal expansion is great between the zirconia ceramics which is the solid electrolyte and the ceramic insulator 7, it is desired that the sensing element 1 and the heater element 2 are separately fabricated and are, then, joined together as shown in FIG. 2.

(Structure of the Heater Device 2).

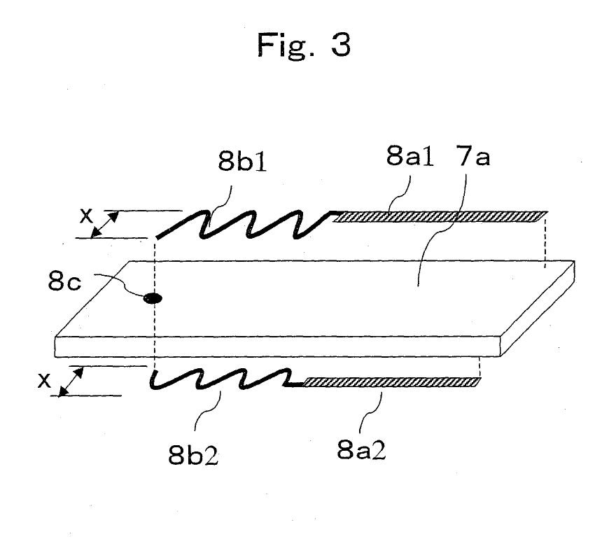

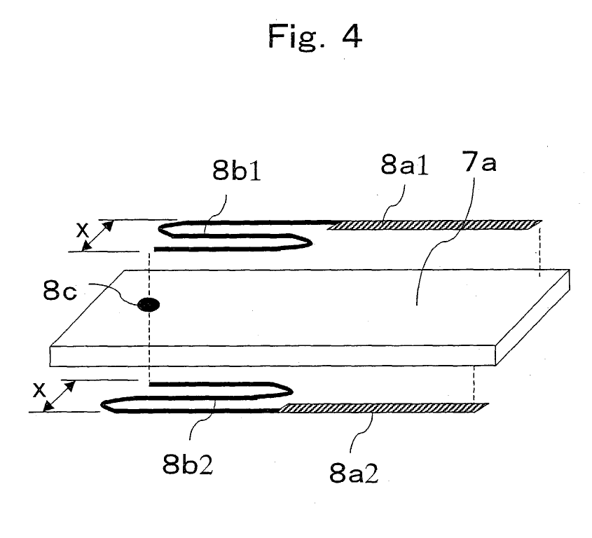

In the present invention, there is no particular limitation on the pattern of the heat-generating members 8 buried in the ceramic insulator 7. For example, the heat-generating member 8 may extend in the lengthwise direction of the oxygen sensor (solid electrolytic substrate 3) and may assume a waved (meandering) pattern being folded at the ends of the oxygen sensor (see FIG. 4 described later) or may assume a waved (meandering) pattern folded at the ends in a direction at right angles with the lengthwise direction (see FIG. 3 described later). In general, further, a pair of heat-generating members 8 are buried in the ceramic insulator 7.

In order to enhance the heating efficiency by the heater device 2 and to lower the stress caused by a difference in the coefficient of thermal expansion between the materials, it is also allowable, as shown in FIG. 1, to form a ceramic layer 9 having a coefficient of thermal expansion which is the same as, or similar, to that of the solid electrolytic substrate 3 on the surface of the side opposite to the side on where the heater device 2 comes in contact with the sensing element 1.

There is no particular limitation on the structure of the heater device 2 so far as the above-mentioned conditions related to the area S of the measuring electrode 5, width w of the sensing element 1 and the shape are satisfied. As shown in, for example, FIG. 2, the heater device 2 may be so constructed that the pair of heat-generating members 8 are buried in the ceramic insulator 7 so as to be positioned on the same height (on the same plane). When the pair of heat-generating members 8 are positioned on the same plane, however, the shape of the heater pattern is very limited as the size of the oxygen sensor becomes small. It is therefore desired, as shown in FIG. 1, to employ the structure in which the pair of heat-generating members 8 are buried in the ceramic insulator 7 at different heights or, in other words, a ceramic insulating layer 7a exists between the pair of heat-generating members 8.

FIGS. 3 and 4 illustrate heater patterns of when the pair of heat-generating members 8 are buried at different heights.

In FIG. 3, the heat-generating members 8 are formed on the upper side and on the lower side of the elongated ceramic insulating layer 7a. The upper heat-generating member 8 is constituted by a lead wire 8a1 extending from one end to the other end (end of the sensor) and a heat-generating portion 8b1 located at the end of the sensor where the sensing element 1 is formed. The lower heat-generating member 8, too, is similarly constituted by a lead wire 8a2 and a heat-generating portion 8b2. Further, the heat-generating portions 8b1 and 8b2 are electrically connected together at the ends thereof through a connection member such as a via-conductor 8c formed in the ceramic insulating layer 7a.

In the above structure, it is desired that the heat-generating portions 8b1 and 8b2 are formed in a meandering (waved) pattern as shown in FIG. 3 from the standpoint of enhancing the heating efficiency. For example, the heat-generating portions 8b1 and 8b2 of the waved pattern require a predetermined width x, respectively. If these heat-generating members 8b1 and 8b2 are formed on the same plane, the width w at the end of the sensing element 1 inevitably becomes greater than 2.5 times of the normal width x (w>2.5x). By forming the heat-generating portions 8b1 and 8b2 at different heights as shown in FIG. 1, however, the condition related to the width w of the sensing element 1 becomes w>x, whereby it is made possible to increase the amount of heat that is generated while decreasing the width w of the sensing element 1. In the present invention, it is desired that w≦2.5x and, particularly, w≦2.3x. It is desired that the ceramic insulating layer 7a between the upper and lower heat-generating members 8 has a thickness of from 1 to 300 μm, particularly, from 5 to 100 μm and, more particularly, from 5 to 50 μm from the standpoint of electric insulation.

It is further desired that the ratio of resistance between the lead wire 8a1 and the lead wire 8a2 is so controlled as to lie in a range of from 9:1 to 7:3 at room temperature.

In the example of FIG. 3, the heat-generating portions 8b1 and 8b2 of the heat-generating members 8 have a meandering (waved) pattern folding in a direction at right angles with the lengthwise direction of the sensor. However, the pattern of the heat-generating members is in no way limited thereto only but may be, for example, of a meandering pattern folding at the ends in the lengthwise direction of the sensor as shown in FIG. 4.

(Plane Structure of the Oxygen Sensor)

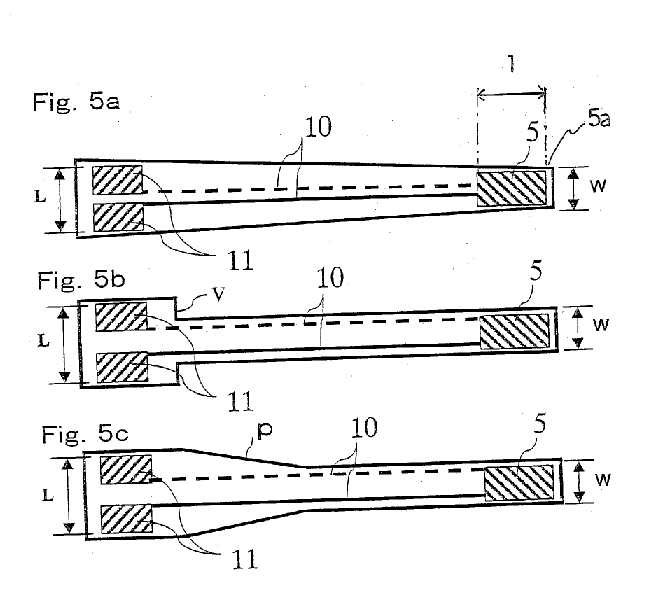

The oxygen sensor of the present invention is forming a sensing element 1 having a measuring electrode 5 formed at the end of the solid electrolytic substrate 3, and has a heater device 2 formed under the sensing element 1. Referring to FIGS. 5a to 5c which are schematic plan views, a pair of electrode pads 11 are formed on the surface of the substrate 3 near the rear end thereof. The electrode pads 11 are connected to the measuring electrode 5 on the front surface of the substrate 3 and to the reference electrode 4 on the back surface of the substrate 3. That is, metallic connectors are connected to the electrode pads 11 to supply an electric power to the heat-generating members 8 and to take out signals from the electrodes 4 and 5 of the sensing element 1 to an external unit. It is further allowable to attach metal pins such as of nickel or the like to the electrode pads 11 by brazing to apply a voltage thereto and to take out signals therefrom.

In the present invention, it is desired that the width L of the pair of electrode pads 11 is greater than the width w of the sensing element 1 at the side of the end of the solid electrolytic substrate 3. Desirably, therefore, the width of the solid electrolytic substrate 3 is decreased continuously or stepwise from the rear end toward the front end on where the sensing element 1 is formed.

Concretely speaking as shown in FIG. 5a, both side surfaces of the solid electrolytic substrate 3 are tapered such that the width thereof is narrowed continuously from the rear end thereof toward the front end thereof. Referring to FIG. 5b, further, a stepped portion v is formed between the front end and the rear end of the solid electrolytic substrate 3, and the width on the side of the front end is narrowed with the stepped portion v as a boundary. Referring further to FIG. 5c, a tapered portion p is formed between the front end and the rear end of the solid electrolytic substrate 3, and the width is gradually narrowed toward the front end within the tapered portion p.

When the width of the solid electrolytic substrate 3 varies in a portion where the measuring electrode 5 is formed as shown in FIG. 5a, the width w of the sensing element 1 (width at the end of the solid electrolytic substrate 3) stands for a width of the substrate 3 of a portion where an end 5a of the measuring electrode 5 is located.

As described above, the width L of a portion where the electrode pad 11 is provided is broadened to be greater than the width w of the sensing element 1 where the measuring electrode 5 is formed, to realize the sensing element 1 in a small size as well as to easily and strongly attach the connectors or metal pins to the electrode pads 11.

In the above-mentioned oxygen sensor of the present invention, it is desired that the width L of the pair of electrode pads 11 is usually in a range of from 4 to 5 mm and, particularly, from 4 to 4.5 mm. It is further necessary that the thickness t of the sensor and the width w of the sensing element 1 are satisfying the above-mentioned conditions at the end of the measuring electrode 5. When the width of the solid electrolytic substrate 3 varies along the lengthwise direction as shown in FIG. 5a, however, it is desired that the above-mentioned conditions are satisfied over the whole portion where the sensing element 1 is formed (i.e., over the portion where the electrodes 4 and 5 are formed).

In the oxygen sensor of the present invention, in general, it is desired that the portion where the sensor element 1 is formed has a thickness t (total thickness of the sensing element 1 and the heater element 2) of from 0.8 to 1.5 mm and, particularly, from 1.0 to 1.2 mm on condition that the requirements related to the shape factor (w·t²) are satisfied. It is further desired that the length of the oxygen sensor (corresponds to the length of the solid electrolytic substrate 3) is in a range of from 45 to 55 mm and, particularly, from 45 to 50 mm, from the standpoint of quickly raising the temperature and easily mounting the sensor in the engine.

According to the present invention, further, the end of the oxygen sensor (end of the solid electrolytic substrate 3 or the end of the ceramic insulator 7) is formed to assume a curved surface of a radius of not larger than 100 mm, or the corner portion is worked to assume a C-plane or an R-plane of not smaller than 0.1 mm to enhance the resistance against heat and shock.

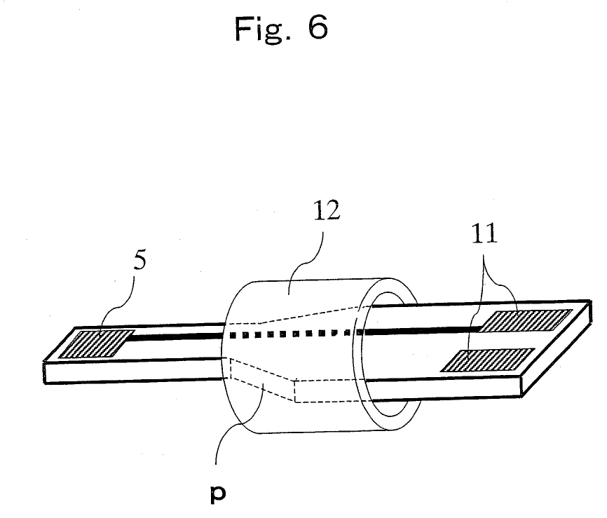

In the oxygen sensor having a structure (shape) of FIG. 5c, further, a mounting jig 12 is attached to the tapered portion p as shown in FIG. 6 so as to be easily attached to a predetermined holder.

(Production of Oxygen Sensor)

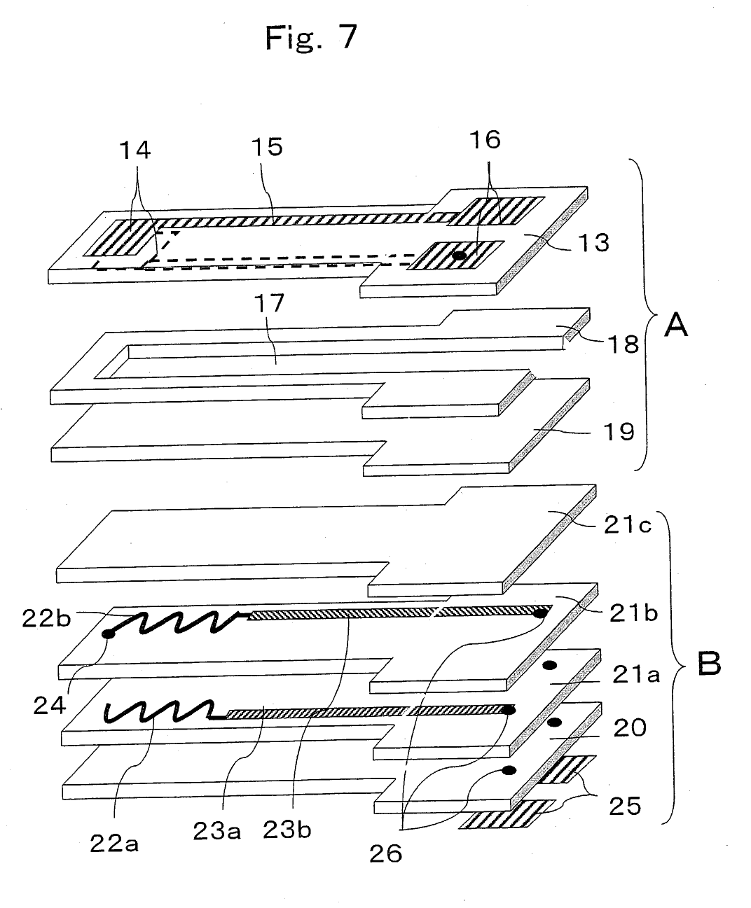

Next, a method of producing the oxygen sensor having the structure of FIG. 5b will be described with reference to FIG. 7 which is a perspective view thereof in a disassembled manner.

First, a solid electrolytic green sheet 13 is formed.

The green sheet 13 is obtained by, for example, adding an organic binder to a solid electrolytic powder of zirconia ceramics having oxygen ion-conducting property to prepare a slurry thereof, which is, then, molded by a known method such as doctor blade method, extrusion-molding method, hydrostatic pressure molding (rubber press) method or press-molding method. The green sheet 13 is further punched to assume a shape of a small width at the front end and a large width at the rear end as shown in FIG. 7.

Next, on both surfaces of the green sheet 13, there are formed patterns 14 that serve as the measuring electrode 5 and the reference electrode 4, lead patterns 15, electrode pad patterns 16, and a through-hole (not shown). They are formed by, for example, printing an electrically conducting paste containing platinum by the slurry-dipping method, screen-printing method, pad-printing method or roll transfer method.

Then, a green sheet 18 forming a reference gas introduction hole 17 and a green sheet 19 are adhered to the green sheet 18 by using an adhesive such as an acrylic resin or an organic solvent, or by a mechanical adhesion while applying a pressure using a roller or the like, thereby to prepare a laminate A that forms a sensing element 1. The green sheets 18 and 19 correspond to the insulating cover 60 of FIG. 1, and are prepared by using a solid electrolytic powder of zirconia ceramics like the green sheet 13. Further, the measuring electrode pattern 14 on the green sheet 13 is adjusted for its printing area such that the electrode area after firing lies within the above-mentioned range of from 8 to 18 mm².

As required, further, a porous slurry is printed onto the surface of the pattern that forms the measuring electrode 5 so as to form a ceramic porous layer 6.

Then, as shown in FIG. 7, a paste of an alumina powder is printed onto the surface of the zirconia green sheet 2 by the slurry-dipping method, screen-printing method, pad-printing method or roll transfer method, thereby to form a ceramic insulating layer 21a.

Next, in order to form a pair of heat-generating members 8 at different heights as shown in FIG. 1, first, a lower heater pattern 22a and a lead pattern 23a are printed onto the surface of the ceramic insulating layer 21a. Then, a ceramic insulating layer 21b is formed by applying an insulating paste such as alumina. An upper heater pattern 22b and a lead pattern 23b are, then, printed onto the surface of the ceramic insulating layer 21b. Another ceramic insulating layer 21c is printed by using the insulating paste to prepare a laminate B of the heater device 2.

In order to connect the lower heater pattern 22a to the upper heater pattern 22b, further, the ceramic insulating layer 21b is formed, a through-hole is perforated in the ceramic insulating layer 21b leading from the surface to the lower heater pattern 22a, and the through-hole is filled with an electrically conducting paste at the time of forming the upper heater pattern 22b thereby to form a via-conductor 24. Or, an end of the ceramic insulating layer 21b is cut away in such a manner that the lower heater pattern 22a is partly exposed, and the electrically conducting paste is applied into the cut-away portion to connect the upper and lower heater patterns together, thereby to form heat-generating members which are connected into one.

Further, electrode pad patterns 25 for heater are formed on the lower surface of the zirconia sheet 20 by using the electrically conducting paste. The electrode pad patterns 25 are electrically connected to the lead patterns 23a and 23b for heater through via-conductors 26 formed in the same manner as the via-conductors 24.

In preparing the laminate B of the heater device 2, the ceramic insulating layers 21a and 21b can be formed even by laminating an insulating sheet formed by a sheet-forming method such as a doctor blade method by using a ceramic slurry such as alumina, in addition to printing the insulating paste that was described above.

Thereafter, the laminate A of the sensing element 1 and the laminate B of the heater device 2 are adhered together by interposing an adhesive such as an acrylic resin or an organic solvent therebetween or by mechanically adhering them together while exerting a pressure by using a roller or the like.

The firing is conducted in the atmosphere or in an inert gas atmosphere in a temperature range of from 1300 to 1700° C. for 1 to 10 hours. During the firing, a substrate such as of smooth alumina is placed as a weight on the laminate A to suppress the laminate A of the sensing element 1 from warping.

Further, when the laminate A of the sensing element 1 and the laminate B of the heater device 2 are fabricated integrally together by co-firing, it is desired to interpose, between the laminate A and the laminate B, a layer of a composite material comprising the solid electrolytic component forming the sensing element 1 and the insulating component forming the ceramic insulating layer of the heater device 2 in order to decrease the stress caused by a difference in the coefficient of thermal expansion between the two.

Then, as required, a porous ceramic layer of at least one kind of ceramics selected from the group consisting of alumina, zirconia and spinel, is formed on the surface of the measuring electrode 14 after firing by the plasma melt-injection method, thereby to obtain an oxygen sensor of the present invention in which the heater device 2 and the sensing element 1 are formed integrally together.

The sensing element 1 and the heater device 2 may be fired separately from each other and may, then, be joined together by using a suitable inorganic adhesive material such as a glass or the like.

On the other hand, when W or an alloy thereof is used as the heat-generating members 8, it is desired to conduct the firing in a reducing gas atmosphere containing an H₂ gas or in an inert gas such as Ar or N₂ at a temperature over a range of from 1300 to 1700° C. for 1 to 10 hours from the standpoint of preventing W from being oxidized.

### EXAMPLES

(Experiment 1)

A λ sensor shown in FIG. 1 was fabricated according to FIG. 7 as described below.

First, there were prepared an alumina powder having a purity of 99.9%, a zirconia powder containing 5% by mol of Y₂O₃ (containing 0.1% by weight of Si), a platinum powder \mathring{1} (having an average particle diameter of 0.1 μm) containing 30% by volume of a zirconia (containing 8% by mol of yttria), and a platinum powder \mathring{2} containing 20% by volume of an alumina powder.

First, a polyvinyl alcohol solution was added to the above zirconia powder to prepare a slurry thereof, which was, then, extrusion-molded to prepare a green sheet 13 of zirconia having a thickness after sintering of 0.4 mm.

Then, an electrically conducting paste containing the platinum powder \mathring{1} was screen-printed onto both surfaces of the green sheet 13 to form electrode patterns 14 that serve as the measuring electrode and the reference electrode, lead patterns 15 and electrode pad patterns 16. Next, a green sheet 18 prepared by using the zirconia powder in the same manner as the green sheet 13 and having an air introduction hole 14 formed therein, and a green sheet 19 prepared by using the zirconia powder in the same manner as the green sheet 13, were laminated on the green sheet 13 by using an acrylic resin adhesive to obtain a laminate A for sensing element. Here, the size of the measuring electrode was so varied that the area thereof after firing was from 5 to 30 mm³.

Next, a paste of the above alumina powder was screen-printed onto the surface of the green sheet 20 of zirconia to form a ceramic insulating layer 21a having a thickness after firing of about 10 μm and, then, a heater pattern 22a and a lead pattern 23a were screen printed by using an electrically conducting paste prepared by using the alumina-containing platinum powder \mathring{2}. The paste of the alumina powder was screen-printed again onto the surface of the ceramic insulating layer 21a to form a ceramic insulating layer 21b.

Onto the ceramic insulating layer 21b were printed a heater pattern 22b and a lead pattern 23b by using an electrically conducting paste prepared by using the alumina-containing platinum powder \mathring{2} relying on the slurry-dipping method, screen-printing method, pad-printing method or roll transfer method. Then, a ceramic insulating layer 21c was formed thereon in the same manner to obtain a laminate B for heater device. The heater patterns 22a and 22b were connected together through a via-conductor formed in the ceramic insulating layer 21b. Thereafter, the laminate A for sensing element and the laminate B for heater device were joined together to obtain a laminate of sensing element incorporating the heater therein, which was, then, fired at 1500° C. for one hour to produce an oxygen sensor incorporating the heater integrally together. At this moment, the width of the laminate A for sensing element and of the laminate B for heater device, was varied to obtain oxygen sensors having various widths in a range of from 1.8 to 4.5 mm (samples Nos. 2 to 23).

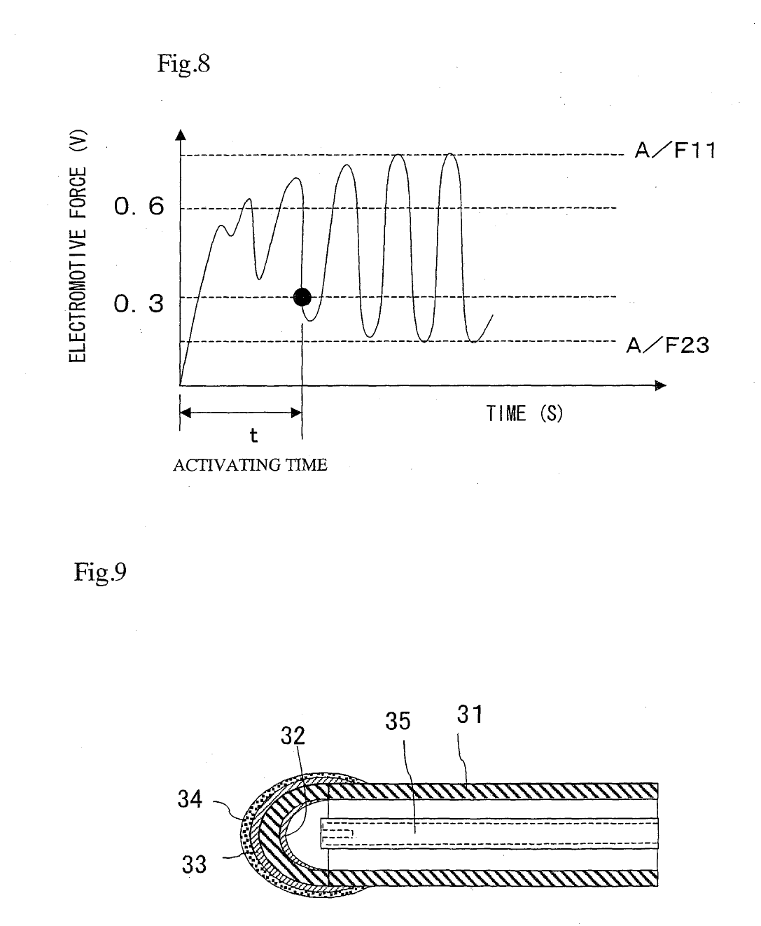

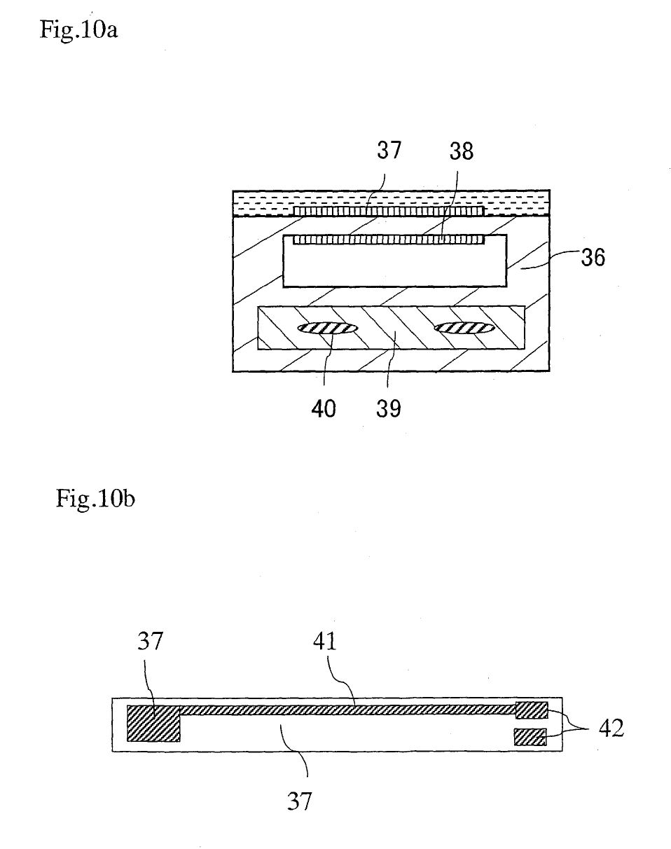

Mixed gases of hydrogen, methane, nitrogen and oxygen and having air-fuel ratios of 12 and 23 were alternately blown onto the thus obtained oxygen sensors at an interval of 0.5 seconds while applying a voltage of 12 V to the heaters in the oxygen sensors, in order to measure the activating times of the sensor elements. Here, as shown in FIG. 8, the time when the voltage was applied to the heater was set to be zero, and a time t until the sensing element produced 0.3 V with the air-fuel ratio of 12, after it has once produced 0.6 V with the air-fuel ratio of 12, was regarded to be the activating time of the element.

For comparison, the same experiment was conducted by using a commercially available flat plate-type heater-incorporating oxygen sensor (sample No. 1) having an element width of 4.5 mm. The results were as shown in Table 1.

TABLE 1

| | Element | Measuring | Activating | |
|---|---|---|---|---|
| Sample | width | electrode | time | |
| No. | w (mm) | area (mm²) | (s) | Remarks |
| *1 | 4.5 | 30 | 17 | commercially |
| | | | | available |
| *2 | 4.0 | 25 | 16 | |
| *3 | 3.8 | 20 | 14 | |
| *4 | 3.0 | 20 | 12 | |
| 5 | 3.0 | 18 | 9 | |
| 6 | 3.0 | 15 | 8 | |
| 7 | 3.0 | 13 | 8 | |
| 8 | 3.0 | 10 | 7 | |
| 9 | 3.0 | 8 | 9 | |
| *10 | 3.0 | 6 | 15 | |
| *11 | 3.8 | 12 | 12 | |
| 12 | 3.5 | 12 | 10 | |
| 13 | 3.2 | 12 | 6 | |
| 14 | 3.0 | 12 | 5 | |
| 15 | 2.8 | 12 | 6 | |
| 16 | 2.5 | 12 | 9 | |
| 17 | 2.0 | 12 | 10 | |
| *18 | 1.8 | 12 | 12 | |
| 19 | 3.5 | 18 | 10 | |
| 20 | 3.1 | 12 | 8 | |
| 21 | 3.1 | 10 | 8 | |
| 22 | 2.5 | 8 | 9 | |
| 23 | 2.0 | 8 | 10 | |

Mark * represents Comparative Examples.

It will be understood from the results of Table 1 that long activating times were exhibited by the samples Nos. 1 to 4, 10, 11 and 18 having measuring electrode areas of sensing elements and having element widths which were deviated from the ranges of 8 to 20 mm² and from the ranges 2 to 3.5 mm of the present invention. On the other hand, the products of the present invention all exhibited activating times of not longer than 10 seconds, proving excellent characteristics yet maintaining small sizes.

(Experiment 2)

By using the powders prepared in Experiment 1, various λ sensors shown in FIGS. 1 and 2 were produced in the same manner as in Experiment 1 in accordance with FIG. 7.

In this Experiment, there were produced the stoichiometric air-fuel ratio type (A type) oxygen sensors incorporating the heater having widths w of from 1.8 to 4.5 mm and w·t² of from 2 to 37 while fixing the thickness of the solid electrolytic substrate 3 to be 0.4 mm, the area of the measuring electrode to be 15 mm² and the width of the heat-generating members to be 1.1 mm while varying the thicknesses of the green sheets and the number of laminations to thereby vary the widths and thicknesses of the laminate A for sensing element and of the laminate B for heater device.

Further, the widths of the oxygen sensors were all set to be 5 mm in the portions where there were formed the electrode pads for sensing element and the electrode pads for heater, and the width L of the pair of electrode pads was selected to be 4.5 mm.

Various oxygen sensors obtained above were measured for their activating times in the same manner as in Experiment 1.

With the operation of elevating the temperature from room temperature up to 1000° C. in about 20 seconds in the atmosphere and, then, cooling the temperature down to room temperature by using a fan as one temperature cycle, the sensing elements were subjected to the temperature cycles of 200,000 times to find the breakage factors. Each group of samples consisted of 10 samples.

For comparison, a commercially available flat plate-type heater-incorporating oxygen sensor (sample No. 9) having an element width of 4.5 mm was also measured for its activating time and the breakage factor of the element. The results were as shown in Table 2.

TABLE 2

| | | Element | Element | | Shape | Activating | Breakage |
|---|---|---|---|---|---|---|---|
| Sample | | width w | thickness | | factor | time | factor |
| No. | Arrangement | (mm) | t (mm) | W/X | w · t² | (s) | (%). |
| *1 | same plane | 4.5 | 1.9 | 4.09 | 16.2 | 18 | 60 |
| 2 | ″ | 3.5 | 1.5 | 3.18 | 7.9 | 10 | 30 |
| *3 | ″ | 3.0 | 0.8 | 2.73 | 1.9 | 10 | 80 |
| 4 | ″ | 3.0 | 1.0 | 2.73 | 3.0 | 8 | 40 |
| 5 | ″ | 3.0 | 1.5 | 2.73 | 6.8 | 7 | 30 |
| 6 | ″ | 3.0 | 2.2 | 2.73 | 14.5 | 8 | 20 |
| 7 | ″ | 3.0 | 3.0 | 2.73 | 27.0 | 8 | 20 |
| *8 | ″ | 3.0 | 3.5 | 2.73 | 36.8 | 14 | 20 |
| *9 | ″ | 4.5 | 1.4 | — | 8.8 | 15 | 60 |
| 10 | different planes | 2.8 | 1.5 | 2.55 | 6.3 | 8 | 10 |
| *11 | ″ | 2.5 | 1.0 | 2.27 | 2.5 | 7 | 70 |
| 12 | ″ | 2.5 | 1.5 | 2.27 | 5.6 | 6 | 20 |
| 13 | ″ | 2.5 | 2.4 | 2.27 | 14.4 | 8 | 10 |
| *14 | ″ | 2.5 | 3.6 | 2.27 | 32.4 | 12 | 50 |
| 15 | ″ | 2.2 | 2.2 | 2.00 | 10.6 | 6 | 20 |
| 16 | ″ | 2.0 | 2.0 | 1.82 | 8.0 | 8 | 10 |
| *17 | ″ | 1.8 | 1.5 | 1.64 | 4.1 | 13 | 40 |

Mark * represents Comparative Examples.
Sample No. 9 is a commercially available product.

As will be obvious from the results of Table 2, elongated activating times were exhibited by a sample No. 1 having an element width w of not smaller than 3.5 mm and by a sample No. 17 having an element width w of not larger than 2.0 mm.

The samples Nos. 8 and 14 having a shape factor of not smaller than 28 exhibited long activating times. On the other hand, the oxygen sensors of the present invention all exhibited activating times of not longer than 10 seconds, and breakage factors of the elements due to the heat cycles were as low as 40% or less.

1. An oxygen sensor comprising a solid electrolytic substrate of ziconia of the shape of an elongated flat plate, a measuring electrode and a reference electrode, said measuring electrode and said reference electrode being formed on both opposing surfaces at a front end portion of said solid electrolytic substrate so as to be opposed to each other and forming a sensing element, wherein said measuring electrode has an electrode area of from 8 to 18 mm², and said sensing element has a width w of from 2.0 to 3.5 mm at a side of a front end of the solid electrolytic substrate.

2. An oxygen sensor according to claim 1, wherein said measuring electrode is formed on an outer surface of the solid electrolytic substrate of zirconia, said reference electrode is formed on an inner surface of the solid electrolytic substrate of zirconia, a ceramic cover having a reference gas introduction hole is provided on the inner surface of the solid electrolytic substrate of a zirconia, and said reference electrode is exposed in said reference gas introduction hole.

3. An oxygen sensor according to claim 2, wherein said ceramic cover is made of a solid electrolyte of zirconia.

4. An oxygen sensor according to claim 1, wherein the thickness t (mm) of the oxygen sensor satisfies a condition represented by the following formula,
3≦w·t²≦28
wherein w is a width (mm) of the sensing element at the side of the front end of the solid electrolytic substrate.

5. An oxygen sensor according to claim 1, wherein a pair of electrode pads are formed on the outer surface of said solid electrolytic substrate at a rear end thereof, the electrode pads being electrically connected to the reference electrode and to the measuring electrode, the width of said solid electrolytic substrate in a direction at right angles with the lengthwise direction thereof decreasing continuously or stepwise from the rear end thereof toward the front end thereof, and the width of the pair of electrode pads being greater than the width at the front end of the solid electrolytic substrate.

6. An oxygen sensor according to claim 2, wherein a heater device made of a ceramic insulator having a heat-generating member buried therein is formed on said ceramic cover integrally with said sensing element.

7. An oxygen sensor according to claim 6, wherein said sensing element and said heater device are formed by co-firing.

8. An oxygen sensor according to claim 6, wherein said sensing element and said heater device are separately formed and are, then, joined together with a junction member.

9. An oxygen sensor according to claim 6, wherein a pair of heat-generating members are buried in the ceramic insulator and are arranged at different planes.

10. An oxygen sensor according to claim 9, wherein a difference of height between said pair of heat-generating members is from 1 to 300 μm.

11. An oxygen sensor according to claim 10, wherein a maximum width x (mm) of each the heat-generating members in a direction at right angles with the lengthwise direction thereof and a width w (mm) of said sensing element at the end of the solid electrolytic substrate, are satisfying a condition represented by the following formula,
w≦2.5x.
